(19) United States
(12) Patent Application Publication
(10) Pub. No.: US 2013/0024723 A1
(43) Pub. Date: Jan. 24, 2013

(54) DISK STORAGE SYSTEM WITH TWO DISKS PER SLOT AND METHOD OF OPERATION THEREOF

(71) Applicant: Raghuraman Govindasamy, San Jose, CA (US)

(72) Inventor: Raghuraman Govindasamy, San Jose, CA (US)

(73) Assignee: PROMISE TECHNOLOGY, INC., Milpitas, CA (US)

(21) Appl. No.: 13/186,328

(22) Filed: Jul. 19, 2011

(51) Int. Cl. G06F 11/20

(52) U.S. Cl. 714/6.22; 714/E11.098

(57) ABSTRACT

A method of operation of a disk storage system includes: providing a disk storage controller; coupling a storage carrier, having a first physical disk and a second physical disk, to the disk storage controller; detecting a failure of the first physical disk; writing a non-volatile memory to show the second physical disk is unavailable when the storage carrier is de-coupled from the disk storage controller; and logging a first written stripe in the non-volatile memory for update when the second physical disk is not available including updating only the written stripe in the second physical disk when the storage carrier is again coupled to the disk storage controller.

### TECHNICAL FIELD

The present invention relates generally to a disk storage system, and more particularly to a system for managing a system having multiple disks in storage apparatus.

### BACKGROUND ART

Conventional disk array data storage systems have multiple disk storage devices that are arranged and coordinated to form a single mass storage system. A Redundant Array of Independent Disks (RAID) system is an organization of data in an array of mass data storage devices, such as hard disk drives, to achieve varying levels of data availability and system performance.

RAID systems typically designate part of the physical storage capacity in the array to store redundant data, either mirror or parity. The redundant information enables regeneration of user data in the event that one or more of the array's member disks, components, or the access paths to the disk(s) fail.

The use of disk mirroring is referred to as RAID Level 1, where original data is stored on one set of disks and a duplicate copy of the data is kept on separate disks. The use of parity checking is referred to as RAID Levels 2, 3, 4, 5, and 6.

In the event of a disk or component failure, redundant data is retrieved from the operable portion of the system and used to regenerate or rebuild the original data that is lost due to the component or disk failure. Accordingly, to minimize the probability of data loss during a rebuild in a hierarchical RAID system, there is a need to manage data recovery and rebuild that accounts for data availability characteristics of the hierarchical RAID levels employed. While a data recovery process is taking place, any additional failure would result in loss of the original user data.

Thus, a need still remains for a disk storage system with two disks per slot. In view of the overwhelming reliance on database availability, it is increasingly critical that answers be found to these problems. In view of the ever-increasing commercial competitive pressures, along with growing consumer expectations and the diminishing opportunities for meaningful product differentiation in the marketplace, it is critical that answers be found for these problems. Additionally, the need to reduce costs, improve efficiencies and performance, and meet competitive pressures adds an even greater urgency to the critical necessity for finding answers to these problems.

Solutions to these problems have been long sought but prior developments have not taught or suggested any solutions and, thus, solutions to these problems have long eluded those skilled in the art.

### DISCLOSURE OF THE INVENTION

The present invention provides a method of operation of a disk storage system including: providing a disk storage controller; coupling a storage carrier, having a first physical disk and a second physical disk, to the disk storage controller; detecting a failure of the first physical disk; writing a non-volatile memory to show the second physical disk is unavailable when the storage carrier is de-coupled from the disk storage controller; and logging a first written stripe in the non-volatile memory for update when the second physical disk is not available including updating only a written stripe in the second physical disk when the storage carrier is again coupled to the disk storage controller.

The present invention provides a disk storage system, including: a disk storage controller; a storage carrier, having a first physical disk and a second physical disk, coupled to the disk storage controller; a non-volatile memory written to show the first physical disk failed and the second physical disk is unavailable when the storage carrier is de-coupled from the disk storage controller; and a first written stripe logged in the non-volatile memory for update when the second physical disk is not available including only the first written stripe rebuilt in the second physical disk when the storage carrier is again coupled to the disk storage controller.

Certain embodiments of the invention have other steps or elements in addition to or in place of those mentioned above. The steps or element will become apparent to those skilled in the art from a reading of the following detailed description when taken with reference to the accompanying drawings.

### BRIEF DESCRIPTION OF THE DRAWINGS

FIG. 1 is a block diagram of a disk storage system, in an embodiment of the present invention.

FIG. 2 is a functional block diagram of a restoration process of the disk storage system.

FIG. 3 is a flow chart of a disk monitoring process of the disk storage system.

FIG. 4 is a flow diagram of a drive rebuild process of the disk storage system.

FIG. 5 is a flow chart of a method of operation of a disk storage system in a further embodiment of the present invention.

### BEST MODE FOR CARRYING OUT THE INVENTION

The following embodiments are described in sufficient detail to enable those skilled in the art to make and use the invention. It is to be understood that other embodiments would be evident based on the present disclosure, and that system, process, or mechanical changes may be made without departing from the scope of the present invention.

In the following description, numerous specific details are given to provide a thorough understanding of the invention. However, it will be apparent that the invention may be practiced without these specific details. In order to avoid obscuring the present invention, some well-known circuits, system configurations, and process steps are not disclosed in detail.

The drawings showing embodiments of the system are semi-diagrammatic and not to scale and, particularly, some of the dimensions are for the clarity of presentation and are shown exaggerated in the drawing FIGs. Similarly, although the views in the drawings for ease of description generally show similar orientations, this depiction in the FIGs. is arbitrary for the most part. Generally, the invention can be operated in any orientation.

For expository purposes, the term “horizontal” as used herein is defined as a plane parallel to the plane or surface of the disk drive, regardless of its orientation. The term “vertical” refers to a direction perpendicular to the horizontal as just defined. Terms, such as “above”, “below”, “bottom”, “top”, “side” (as in “sidewall”), “higher”, “lower”, “upper”, “over”, and “under”, are defined with respect to the horizontal plane, as shown in the figures. The term “on” means that there is direct contact between elements.

Typically, the disk drives are allocated into equally sized address areas referred to as “blocks.” A set of blocks that has the same unit address ranges from each of the physical disks is referred to as a “stripe” or “stripe set.” The terms “coupling” and “de-coupling” means inserting and removing a storage tray containing one or more disk drives from a storage enclosure supporting a random array of independent disks. The insertion causes the electrical and physical connection between the disk drives and the storage enclosure, which includes a disk storage controller known as a RAID controller.

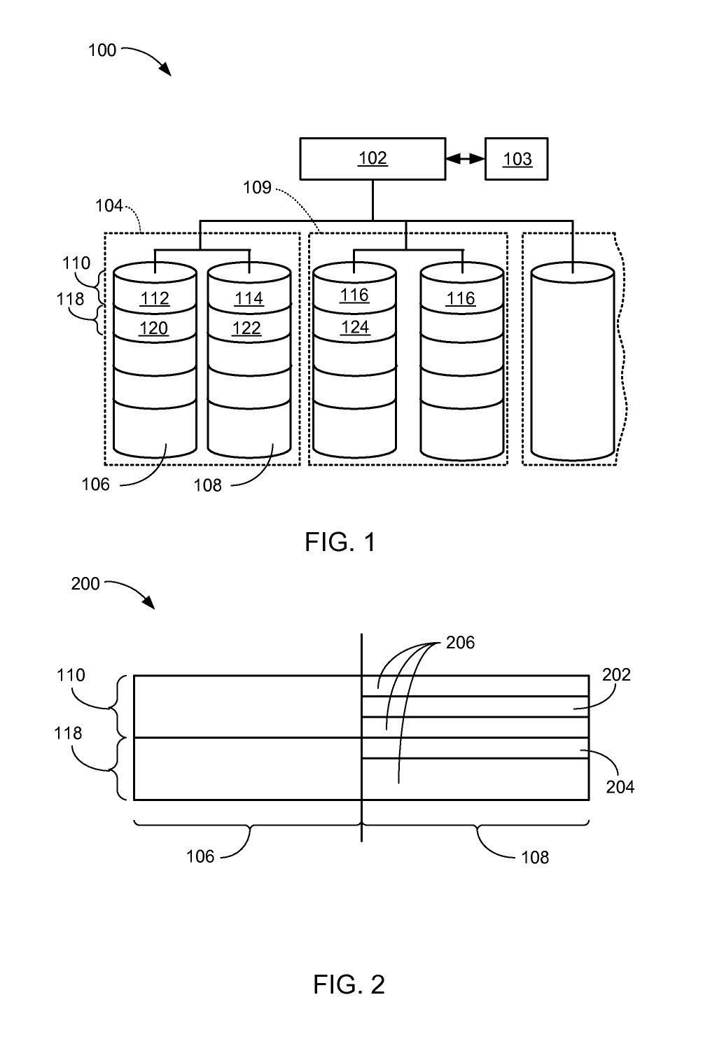

Referring now to FIG. 1, therein is shown a block diagram of a disk storage system 100, in an embodiment of the present invention. The block diagram of the disk storage system 100 depicts a disk storage controller 102, having a non-volatile memory 103, connected to a number of storage carriers 104, such as shelves or drawers, each containing a first physical disk 106 and a second physical disk 108. The non-volatile memory 103, such as a flash memory, is used to store configuration information and process related information.

An additional storage carrier 109 may contain more units of the first physical disk 106 and the second physical disk 108. The disk storage controller 102 may configure the storage carriers 104 and the additional storage carrier 109 by reading a serial number of the first physical disk 106 and the second physical disk 108 in each and allocating space for them in the non-volatile memory 103.

The storage carriers 104 and the additional storage carrier 109 may be configured as a random array of independent disks (RAID), to include a first logical drive 110, such as a Logical Unit Number (LUN), which may be formed by a first group of allocated sectors 112 on the first physical disk 106, a second group of allocated sectors 114 on the second physical disk 108. The first logical drive 110 may also include additional groups of allocated sectors 116 in the additional storage carrier 109. It is understood that the first logical drive 110, of a RAID, must be written on more than a first physical disk 106 and can be written on any number of the physical disks in the disk storage system 100.

The collective allocated sectors of the first logical drive 110 may be accessed through the disk storage controller 102 as a LUN. A second logical drive 118 may be formed by a third group of allocated sectors 120 on the first physical disk 106, a fourth group of allocated sectors 122 on the second physical disk 108. The second logical drive 118 may also include other allocated sectors 124 on other of the storage carriers 104. Each of the logical unit numbers, such as the first logical drive 110 and the second logical drive 118 may be accessed independently by a host system (not shown) through the disk storage controller 102.

In normal operation, the disk storage controller 102 would write data to and read data from the first logical drive 110 and the second logical drive 118. The operation is hidden from the host system, which is unaware of the storage carriers 104 or the first physical disk 106 and the second physical disk 108 contained within each of the storage carriers 104.

In the operation of the disk storage system 100, if a data error is detected while reading the first logical drive 110 the error may be corrected without notification being sent to the host system. If, during normal operation of the disk storage system 100, a failure occurs in the first physical disk 106, the storage carrier 104 containing the first physical disk 106 and the second physical disk 108 may be de-coupled from the disk storage controller 102 in order to replace the first physical disk 106. The non-volatile memory 103 is written to indicate the first physical disk 106 is a failed drive 106 and the second physical disk 108 is a good drive 108 that is unavailable due to de-coupling. The failure of the first physical disk 106, which is detected by the disk storage controller 102, may be a data error, a command time-out, loss of power, or any malfunction that prevents the execution of pending or new commands. It is understood that the detection of the failed drive 106 may be in any location of any of the storage carriers 104 that are installed in the storage enclosure (not shown). It is further understood that the good drive 108 is the other physical disk installed in the storage carrier 104 that contains the failed drive 106.

Upon restoring the storage carrier 104 to the disk storage system 100, a process is entered to rebuild the data content of the first group of allocated sectors 112 on the first logical drive 110 and the third group of allocated sectors 120 on the second logical drive 118 that collectively reside on the first physical disk 106. While the storage carrier 104 is removed from the disk storage system 100, any data read from the second group of allocated sectors 114 or the fourth group of allocated sectors 122 on the second physical disk 108 may be regenerated through a mirror or parity correction process.

If a write operation takes place to the second group of allocated sectors 114 or the fourth group of allocated sectors 122 on the second physical disk 108, while the storage carrier 104 is removed from the disk storage system 100, a special rebuilding process must be used to update the data when the second physical disk 108 is once again plugged in to the disk storage system 100 and coupled to the disk storage controller 102. During the special rebuilding process any additional failure would result in the data being unrecoverable. It is therefore essential that the data on the first physical disk 106 and the second physical disk 108 be restored a quickly and efficiently as possible.

The dramatic increase in the storage capacity of the first physical disk 106 and the second physical disk 108 has increased the amount of time required to rebuild any lost data on a newly installed unit of the first physical disk 106. It is therefore essential that an efficient and rapid rebuild of the data is required to prevent any data loss in the disk storage system 100 due to a second failure that might occur prior to the complete restoration of the data.

It has been discovered that the second physical disk 108 comes back on-line in a shorter duration by, instead of rebuilding the entire drive, rebuilding only the stripes that have been written while the second physical disk 108 was de-coupled from the disk storage controller 102. The data on the other stripe(s) are correct without requiring any additional operation. The overall time required to restore the second physical disk 108 is therefore substantially reduced. The total resource of the disk storage system 100 may then be applied to the operation of restoring the data to the first physical disk 106, which has been replaced. It is also understood that the operation of the disk storage system 100 continues during the failure and rebuilding of the first physical disk 106 and the removal of the storage carrier 104.

Referring now to FIG. 2, therein is shown a functional block diagram of a restoration process 200 of the disk storage system 100. The functional block diagram of the restoration process 200 depicts the first physical disk 106, which may have been replaced due to a previous failure. The entirety of the first logical drive 110 and the second logical drive 118 on the first physical disk 106 must be restored.

In order to facilitate the disk storage system 100 of the present invention, the first logical drive 110 and the second logical drive 118 may be split into many small stripes and the status of the each stripe may be maintained in the non-volatile memory 103, of FIG. 1. The state of the stripes may be set to stripe consistent, written, online, critical, or degraded. A table may be maintained in the non-volatile memory 103 to record the write log for every stripe in the first logical drive 110 and the second logical drive 118. The table may include 1 bit per stripe and each stripe to have a maximum of 1 GB physical capacity.

When the second physical disk 108 is once again available for operation, after the replacement of the first physical disk 106, a selective restoration of the data may be performed. A first written stripe 202 is a segment of data within the first logical drive 110 that may be restored in the second physical disk 108. A subsequent written stripe 204, within the second logical drive 118, may be restored before the second physical disk 108 may be fully put on-line by the disk storage controller 102, of FIG. 1.

It is understood that the first written stripe 202, while found in the first logical drive 110, may span multiple units of the storage carriers 104 and be written on the first physical disk 106 and the second physical disk 108 of each. By way of an example, the first written stripe 202 is shown only on the good drive 108 and not on the failed drive 106.

Un-written stripes 206 may be located in the first logical drive 110 and the second logical drive 118. The un-written stripes 206 in the second physical disk 108 are in the correct state without being restored by the disk storage controller 102. By monitoring the locations of the first written stripe 202 and the subsequent written stripe 204 in the second physical disk 108, the disk storage controller 102 may expedite the process of restoring the second physical disk 108 to full on-line status.

It is understood that the position of the un-written stripes 206 is an example only and the first logical drive 110, the second logical drive 118, or the combination thereof may contain the un-written stripes 206 in any location. It is further understood that the first written stripe 202 and the subsequent written stripe 204 are an example only and any number of the stripes in the first logical drive 110 and the second logical drive 118 may have been written while the second physical disk 108 was removed from the disk storage system 100.

During the initialization of the disk storage system 100, the disk storage controller 102 will record the serial numbers of the first physical disk 106 and the second physical disk 108 in each of the storage carriers 104. The serial number of each of the first physical disk 106 and the second physical disk 108 will be checked when the storage carrier 104 is removed and replaced. The disk storage controller 102 is aware of which of the first physical disk 106 or the second physical disk 108 has experienced a failure and which is expected not to be changed.

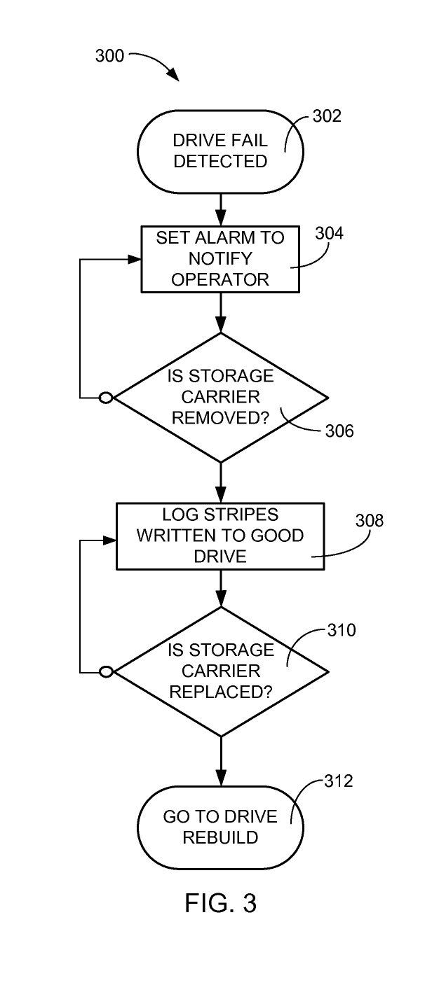

Referring now to FIG. 3, therein is shown a flow chart of a disk monitoring process 300 of the disk storage system 100. The flow chart of the disk monitoring process 300 depicts operations performed by the disk storage controller 102, of FIG. 1, during the operation of the disk storage system 100. If a physical disk drive responds with an error status or fails to respond to a command, the disk storage controller 102 enters a drive failure detected block 302 in order to manage the failure.

Having identified the failed disk drive and the storage carrier 104 of FIG. 1 to which it belongs, the flow enters a set alarm block 304. The disk storage controller 102 may activate an interface circuit to notify the operator of the location of the storage carrier 104 impacted and which of the first physical disk 106, of FIG. 1, or the second physical disk 108, of FIG. 1, has failed. The disk storage controller 102 may update the non-volatile memory 103, of FIG. 1, to indicate which of the first physical disk 106 or the second physical disk 108 has failed and which is unavailable.

The flow will proceed to a storage carrier removed block 306. The disk storage controller 102 will maintain normal operations of the first physical disk 106 or the second physical disk 108 that has not failed until the operator actually removes the storage carrier 104. If the storage carrier 104 has not been removed the flow returns to the set alarm block 304.

When the storage carrier 104 is detected as being removed the flow proceeds to a log written stripes block 308 in order to monitor which might be the first written stripe 202, of FIG. 2, of the now removed good drive. Any of the subsequent written stripe 204 that is written while the good drive is out of the disk storage system 100, of FIG. 1, will be noted in the non-volatile memory 103, of FIG. 1. If the storage carrier 104 has not been replaced, the flow returns to the log written stripes block 308.

When the storage carrier 104 is replaced, the flow proceeds to a drive rebuild block 312. If at this time any write transactions for the good drive may be copied directly to the first physical disk 106 or the second physical disk 108.

It is understood that the logging of the first written stripe 202 may be represented by a single bit location in the non-volatile memory 103. As the good drive is processed to make the stripes consistent, the bit in the non-volatile memory 103 might be cleared.

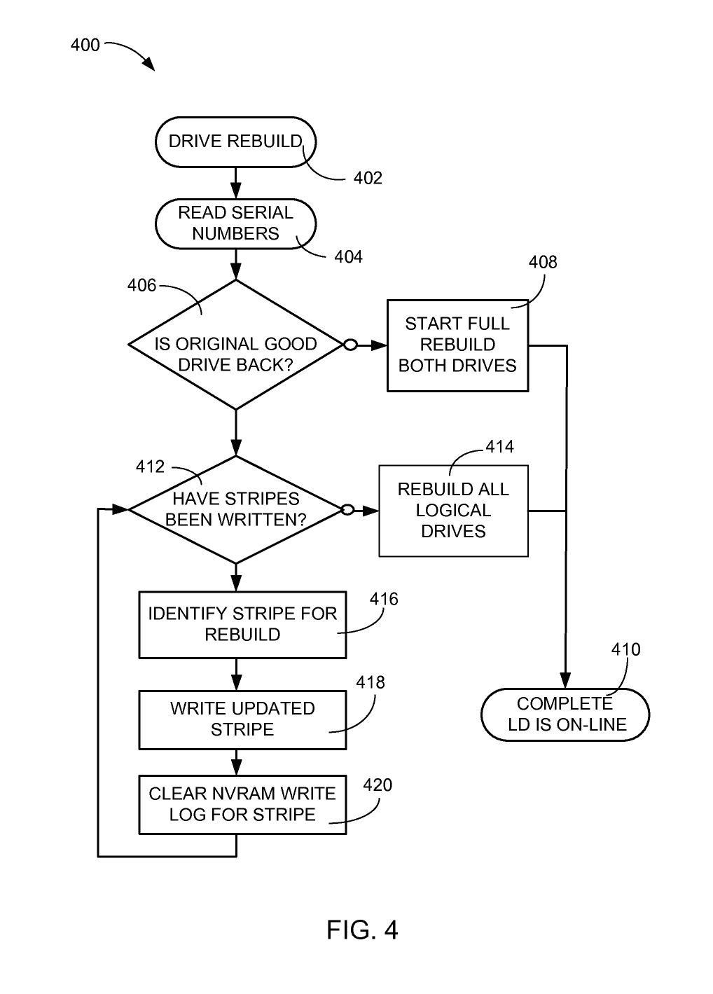

Referring now to FIG. 4, therein is shown a flow diagram of a drive rebuild process 400 of the disk storage system 100, of FIG. 1. The flow diagram of the drive rebuild process 400 depicts a drive rebuild entry 402, which immediately proceeds to a read serial numbers block 404. In this step, the disk storage controller 102, of FIG. 1, may interrogate the first physical disk 106, of FIG. 1, or the second physical disk 108, of FIG. 1, whichever was not the failed disk drive in order to retrieve its serial number.

The disk storage controller 102 will then proceed to a verify original drive block 406. The disk storage controller 102 may interrogate the non-volatile memory 103, of FIG. 1, in order to determine whether the good disk drive is once again installed. If the serial number of the good drive does not match the contents of the non-volatile memory 103 the flow proceeds to a start rebuild block 408.

The start rebuild block 408 may start a rebuild of both of the first physical disk 106 and the second physical disk 108 in order to restore the first logical drive 110, of FIG. 1, and the second logical drive 118, of FIG. 1. When the rebuild is complete the flow proceeds to a complete block 410 in order to set the first logical drive 110 and the second logical drive 118 on-line with an appropriate status entered into the non-volatile memory 103. The status may include consistent, critical, degraded, on-line, or written. When the complete block 410 updates the status the non-volatile memory 103 should indicate on-line.

If the correct serial number is detected for the good drive, the flow moves to a check for stripes written block 412. The disk storage controller 102 may interrogate the non-volatile memory 103 to access a table of all of the stripes written since the good drive was removed. The table may include a single bit for each stripe that was written while the good drive was uninstalled.

If none of the stripes of the first logical drive 110 and the second logical drive 118 was written the flow will move to a rebuild logical drives block 414. The rebuild of the first logical drive 110 and the second logical drive 118 on the failed drive may occur in a background operation to the normal operation of the disk storage system 100. When the rebuild is complete the flow moves to the complete block 410 in order to set the first logical drive 110 and the second logical drive 118 on-line with an appropriate status entered into the non-volatile memory 103.

If the disk storage controller 102 determines that the table in the non-volatile memory 103 indicates that the first written stripe 202, of FIG. 2, was processed while the good drive was uninstalled, the flow proceeds to an identify stripe block 416 in order to identify which of the stripes in the first logical drive 110 or the second logical drive 118 must be updated. The flow then quickly moves through a write updated stripe block 418, in order to physically write the stripe, and a clear write log 420 to clear the indicator for the stripe that was just updated. The flow then returns to the check for stripes written block 412.

It has been discovered that after a failure of the first physical disk 106, the storage carrier 104 having the first physical disk 106 and the second physical disk 108 can be brought on-line in a shorter time because only the stripes that have been written while the good disk was unavailable are updated.

Thus, it has been discovered that the disk storage system of the present invention furnishes important and heretofore unknown and unavailable solutions, capabilities, and functional aspects for managing a rebuild of a physical disk pair.

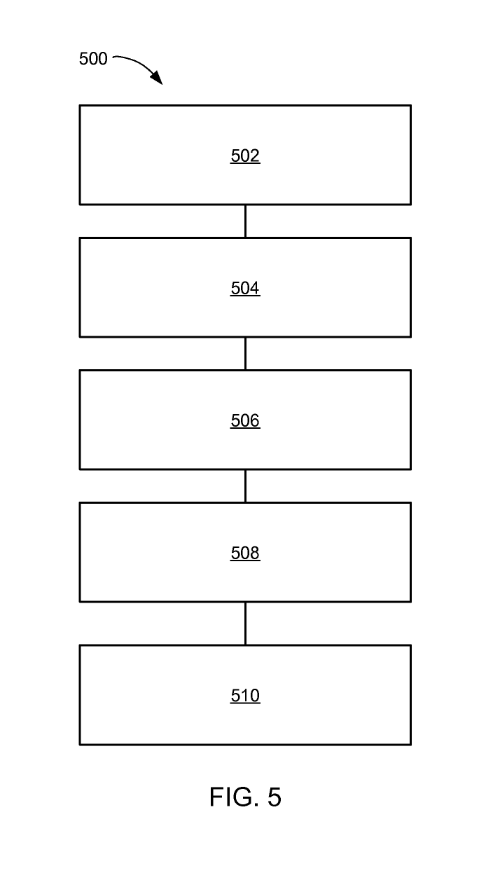

Referring now to FIG. 5, therein is shown a flow chart of a method 500 of operation of a disk storage system in a further embodiment of the present invention. The method 500 includes: providing a disk storage controller in a block 502; coupling a storage carrier, having a first physical disk and a second physical disk, to the disk storage controller in a block 504; detecting a failure of the first physical disk in a block 506; writing a non-volatile memory to show the second physical disk is unavailable when the storage carrier is de-coupled from the disk storage controller in a block 508; and logging a first written stripe in the non-volatile memory for update when the second physical disk is not available including updating only a written stripe in the second physical disk when the storage carrier is again coupled to the disk storage controller in a block 510.

The resulting method, process, apparatus, device, product, and/or system is straightforward, cost-effective, uncomplicated, highly versatile, accurate, sensitive, and effective, and can be implemented by adapting known components for ready, efficient, and economical manufacturing, application, and utilization.

Another important aspect of the present invention is that it valuably supports and services the historical trend of reducing costs, simplifying systems, and increasing performance.

These and other valuable aspects of the present invention consequently further the state of the technology to at least the next level.

While the invention has been described in conjunction with a specific best mode, it is to be understood that many alternatives, modifications, and variations will be apparent to those skilled in the art in light of the aforegoing description. Accordingly, it is intended to embrace all such alternatives, modifications, and variations that fall within the scope of the included claims. All matters hithertofore set forth herein or shown in the accompanying drawings are to be interpreted in an illustrative and non-limiting sense.

What is claimed is:

1. A method of operation of a disk storage system comprising:
providing a disk storage controller;
coupling a storage carrier, having a first physical disk and a second physical disk, to the disk storage controller;
detecting a failure of the first physical disk;
writing a non-volatile memory to show the second physical disk is unavailable when the storage carrier is de-coupled from the disk storage controller; and
logging a first written stripe in the non-volatile memory for update when the second physical disk is not available including updating only the written stripe in the second physical disk when the storage carrier is again coupled to the disk storage controller.

2. The method as claimed in claim 1 further comprising partitioning a first logical drive on the first physical disk and the second physical disk.

3. The method as claimed in claim 1 further comprising detecting a failed drive by the disk storage controller.

4. The method as claimed in claim 1 further comprising writing a serial number for the first physical disk and the second physical disk in the non-volatile memory.

5. The method as claimed in claim 1 further comprising allocating a first logical drive to include a first group of allocated sectors on the first physical disk and a second group of allocated sectors on the second physical disk.

6. A method of operation of a disk storage system comprising:
providing a disk storage controller;
coupling a storage carrier, having a first physical disk and a second physical disk, to the disk storage controller including coupling an additional storage carrier;
detecting a failure of the first physical disk;
writing a non-volatile memory to show the second physical disk is unavailable when the storage carrier is de-coupled from the disk storage controller; and
logging a first written stripe and a subsequent written stripe in the non-volatile memory for update when the second physical disk is not available including updating only the first written stripe and the subsequent written stripe in the second physical disk when the storage carrier is again coupled to the disk storage controller.

7. The method as claimed in claim 6 further comprising partitioning a first logical drive on the first physical disk and the second physical disk on the additional storage carrier.

8. The method as claimed in claim 6 further comprising detecting a failed drive by the disk storage controller including identifying a location of the storage carrier with the failed drive.

9. The method as claimed in claim 6 further comprising writing a serial number for the first physical disk and the second physical disk in the non-volatile memory including identifying a good drive when the storage carrier is re-coupled to the disk storage controller.

10. The method as claimed in claim 6 further comprising allocating a first logical drive to include a first group of allocated sectors on the first physical disk and a second group of allocated sectors on the second physical disk and a second logical drive to include a third group of allocated sectors on the first physical disk and a fourth group of allocated sectors on the second physical disk.

11. A disk storage system comprising:
a disk storage controller;
a storage carrier, having a first physical disk and a second physical disk, coupled to the disk storage controller;
a non-volatile memory written to show the first physical disk failed and the second physical disk is unavailable when the storage carrier is de-coupled from the disk storage controller; and
a first written stripe logged in the non-volatile memory for update when the second physical disk is not available including only the first written stripe in the second physical disk rebuilt when the storage carrier is again coupled to the disk storage controller.

12. The system as claimed in claim 11 further comprising a first logical drive partitioned on the first physical disk and the second physical disk.

13. The system as claimed in claim 11 further comprising a failed drive detected by the disk storage controller.

14. The system as claimed in claim 11 further comprising a serial number of the first physical disk and the second physical disk written in the non-volatile memory.

15. The system as claimed in claim 11 further comprising a first logical drive includes a first group of allocated sectors on the first physical disk and a second group of allocated sectors on the second physical disk.

16. The system as claimed in claim 11 further comprising an additional storage carrier coupled to the disk storage controller.

17. The system as claimed in claim 16 further comprising a first logical drive on the first physical disk and the second physical disk on the additional storage carrier.

18. The system as claimed in claim 16 further comprising a failed drive detected by the disk storage controller includes a location of the storage carrier with the failed drive marked by the disk storage controller.

19. The system as claimed in claim 16 further comprising a serial number for the first physical disk and the second physical disk written in the non-volatile memory includes a good drive identified when the storage carrier is re-coupled to the disk storage controller.

20. The system as claimed in claim 16 further comprising a first logical drive includes a first group of allocated sectors on the first physical disk and a second group of allocated sectors on the second physical disk and a second logical drive includes a third group of allocated sectors on the first physical disk and a fourth group of allocated sectors on the second physical disk.
